(19) United States
(12) Patent Application Publication
(10) Pub. No.: US 2006/0032791 A1
(43) Pub. Date: Feb. 16, 2006

(54) Screen device

(75) Inventor: Yoshihiko Aikawa, Shizuoka (JP)

Correspondence Address: KANESAKA BERNER AND PARTNERS LLP, SUITE 300, 1700 DIAGONAL RD, ALEXANDRIA, VA, 22314-2848, US

(73) Assignee: AIKAWA IRON WORKS CO.,LTD, Shizuoka (JP)

(21) Appl. No.: 11/172,862

(22) Filed: Jul. 5, 2005

(30) Foreign Application Priority Data
Aug. 9, 2004 (JP) 2004-232533

(51) Int. Cl. B21D 39/00; B01D 29/00

(52) U.S. Cl. 209/411; 162/190; 210/488; 228/170

(57) ABSTRACT

A screen device includes a screen for receiving papermaking raw materials and a stirring member facing an outer surface or inner surface of the screen and rotating to wash a mesh of the screen, so that foreign materials are removed from the papermaking raw materials. The screen includes slits elongated in a longitudinal direction formed by elongated members. The slit is defined by a first screen surface and a second screen surface facing each other. Recess portions are formed at least in the first screen portion surfaces, and each disposed at a position closer to a narrowest facing portion between the first and second screen surfaces relative to an outlet of the first and second screen surfaces through which the papermaking raw materials flow out.

### BACKGROUND OF THE INVENTION AND RELATED ART STATEMENT

The present invention relates to a screen device wherein foreign materials or fibers in papermaking raw materials do not block gaps (slits) of a screen and is not mixed with selected good fibers.

In a screen device, good fibers in papermaking raw materials pass through elongated slits to be selected and foreign materials in the papermaking raw materials do not pass through the elongated slits (for example, see Patent Document 1). Recently, it has been required to reduce a width of the slits for further removing the foreign materials to obtain high-quality papermaking raw materials.

Patent Document 1: Japanese Patent Publication (Kokai) No. 2003-201691

In the screen device mentioned above, when the width of the slits is reduced, it is difficult to pass the papermaking raw materials through the slits, so that the foreign materials or fibers in the fibrous raw materials easily block the slits.

In view of the problems described above, an object of the present invention is to provide a screen device without such problems.

Further objects and advantages of the invention will be apparent from the following description of the invention.

### SUMMARY OF THE INVENTION

In order to attain the objects described above, according to the present invention, a screen device is provided with a screen for receiving papermaking raw materials and a stirring member facing an outer surface or inner surface of the screen and rotating to wash a mesh of the screen, so that foreign materials are removed from the papermaking raw materials. The screen includes slits elongated in a longitudinal direction. A cross section of the slit perpendicular to the longitudinal direction includes a first screen portion surface and a second screen portion surface facing each other. In the first screen portion surface and the second screen portion surface, a recess portion is formed in at least the first screen portion surface. The recess portion is located at a position closer to a narrowest facing portion wherein a distance between the first screen portion surface and second screen portion surface facing each other becomes smallest relative to an outlet end of the first screen portion surface and the second screen portion surface facing each other through which the papermaking raw materials flow out.

According to the screen device of the present invention, in the first screen portion surface and the second screen portion surface facing each other, the recess portion is formed in at least the first screen portion surface. The recess portion is located at the position closer to the narrowest facing portion wherein the distance between the first screen portion surface and second screen portion surface facing each other becomes smallest relative to the outlet end of the first screen portion surface and the second screen portion surface facing each other through which the papermaking raw materials flow out. Accordingly, it is possible to prevent the foreign materials or fibers in fibrous raw materials from blocking the slits and from being mixed with selected good fibers.

### BRIEF DESCRIPTION OF THE DRAWINGS

FIG. 1 is a cross sectional view showing a screen device according to an embodiment of the present invention;

FIG. 2 is a cross sectional view taken along line 2-2 in FIG. 1;

FIG. 3 is a partially enlarged sectional view showing a part of the screen device shown in FIG. 2;

FIG. 4 is a view showing the screen device viewed from a Y direction in FIG. 3;

FIG. 5 is a partially enlarged cross sectional view showing a part of the screen device shown in FIG. 3 in a state wherein papermaking raw materials are fed from a supply-side 1X to a discharge-side 1Y indicated by arrows;

FIG. 6 is a partially enlarged cross sectional view showing a part of the screen device shown in FIG. 3 in a state wherein the papermaking raw materials flow back to the supply-side 1X from the discharge-side 1Y indicated by arrows;

FIG. 7 is a cross sectional view showing a screen member different from those shown in FIGS. 1 and 6; and

FIG. 8 is a cross sectional view showing a screen member different from that shown in FIG. 7.

### DETAILED DESCRIPTION OF PREFERRED EMBODIMENTS

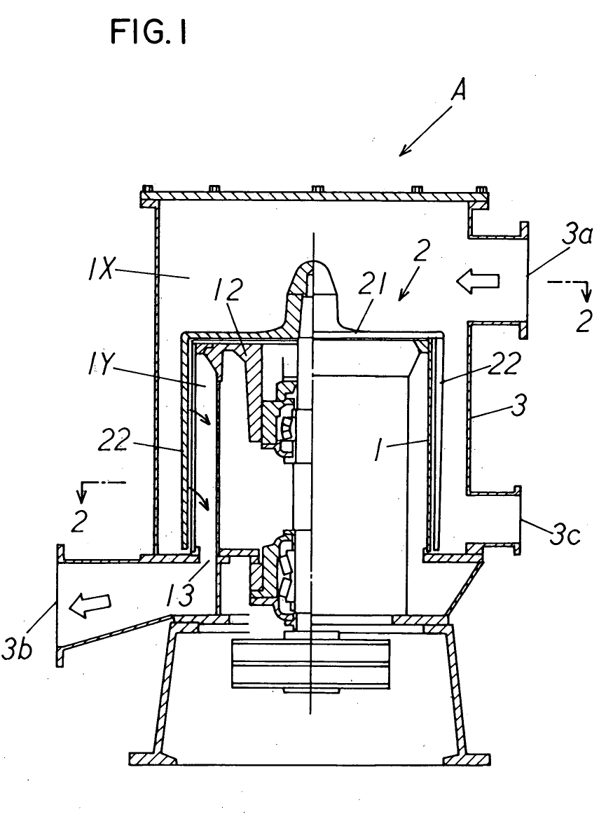

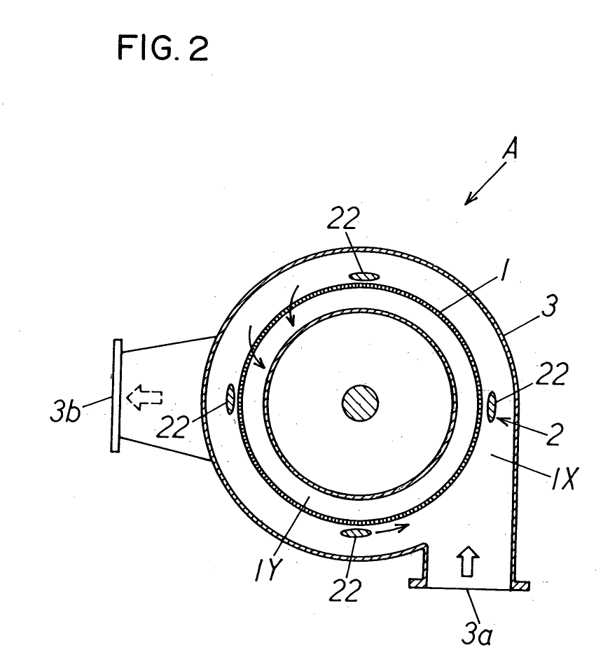

Hereunder, embodiments of the present invention will be explained with reference to the accompanying drawings. As shown in FIGS. 1 to 6, a screen device A is provided with a screen 1 for receiving papermaking raw materials and a stirring member 2 (agitator, foil) facing an outer surface (or inner surface) of the screen 1 and rotating to wash a mesh of the screen 1, so that fibers and foreign materials are separated and the foreign materials are continuously removed from the papermaking raw materials.

The screen 1 and stirring member 2 are provided inside a barrel 3 for receiving the papermaking raw materials. The barrel 3 includes a feed opening 3a for receiving the papermaking raw materials; a papermaking-raw material outlet 3b for discharging the papermaking raw materials passing through the screen 1 outside the barrel 3; and a foreign-body outlet 3c for discharging the papermaking raw materials including the foreign materials which do not pass through the screen 1 outside the barrel 3. The screen 1 includes stick-like elongated members 11 lined up circularly with slits (elongated slits) S, and an outer shape of the screen 1 is substantially cylindrical. The screen 1 is disposed inside the barrel 3, and has a closed ceiling portion 12 and an open base portion 13. The barrel 3 is divided into a supply-side 1X for the papermaking raw materials and a discharge-side 1Y for the papermaking raw materials by the screen 1.

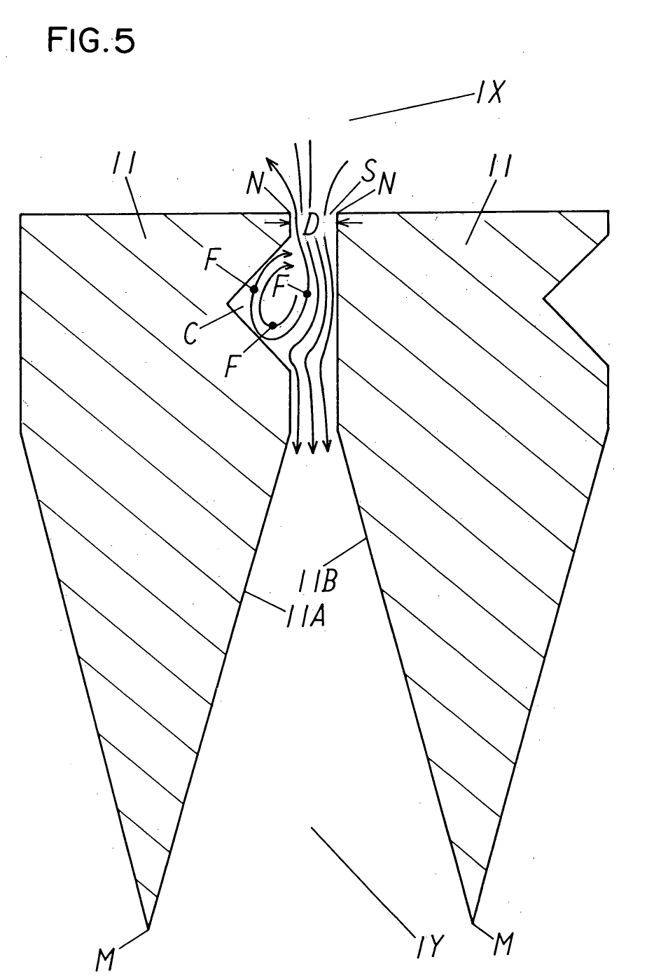

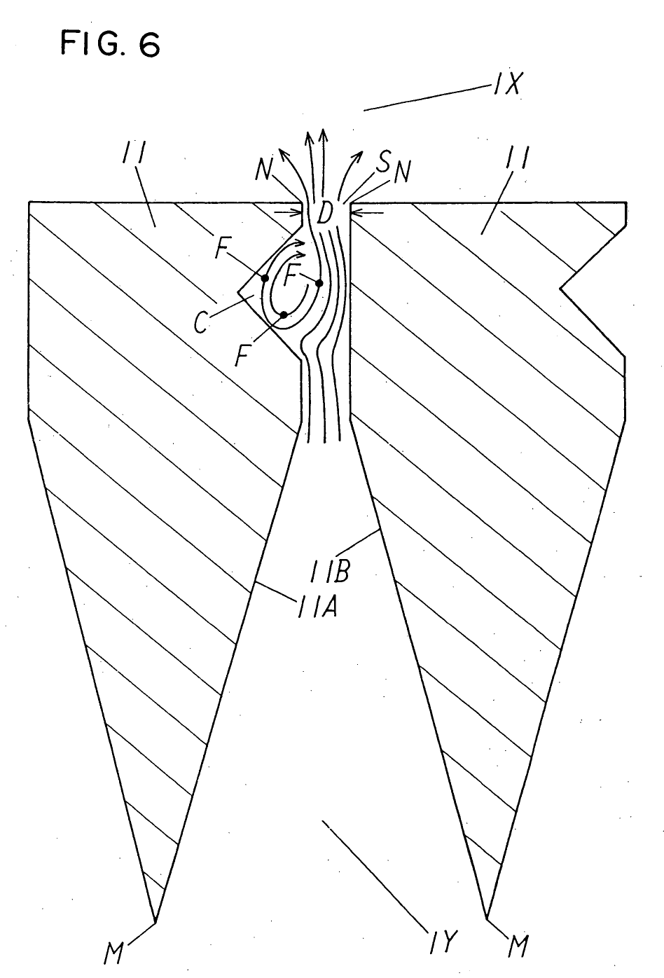

The stirring member 2 has drooping members 22 drooping from a disk-like member 21 sustained above the ceiling portion 12 of the screen 1. The drooping members 22 are rotated by a motor (not shown) via a power transmission member 4. In the embodiment, the stirring member 2 has four drooping members 22. When the stirring member 2 rotates, a positive pressure is applied to the screen 1 at a front side of the stirring member 2 (see FIG. 5), and a negative pressure is applied to the screen 1 at a rear side of the stirring member 2. Accordingly, the papermaking raw materials flow back into the supply-side 1X from the discharge-side 1Y (see FIG. 6). As a result, the slits S of the screen 1 are washed, so that the foreign materials or fibers in fibrous raw materials are prevented from blocking the slits S and continuously removed from the papermaking raw materials.

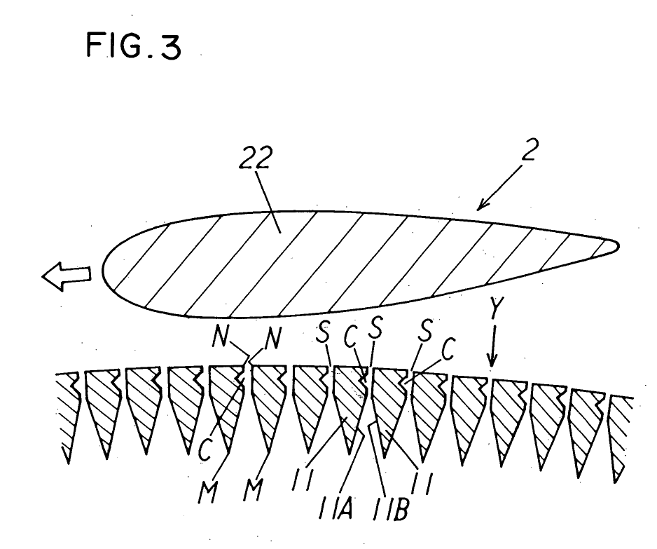

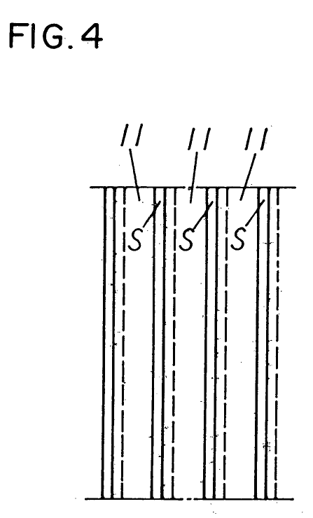

As shown in FIG. 4, the above-mentioned screen S includes the elongated slits S between the elongated members 11. As shown in FIG. 3, cross sections of the elongated slits S perpendicular to a longitudinal direction includes first screen portion surfaces 11A and second screen portion surfaces 11B facing each other. In the first screen portion surfaces 11A and the second screen portion surfaces 11B, recess portions C are formed in the first screen portion surfaces 11B. Each recess portion C is located at a position closer to a narrowest facing portion N wherein a distance D between each first screen portion surface 11A and each second screen portion surface 11B facing each other becomes smallest relative to outlet ends M of the first screen portion surfaces 11A and the second screen portion surfaces 11B facing each other through which the papermaking raw materials flow out (see FIGS. 3, 5, and 6).

With the above-mentioned recess portions C, it is possible to prevent the foreign materials or fibers in the fibrous raw materials from blocking the elongated slits S and being mixed with selected good fibers. These advantages are obtained for the following reasons.

When the papermaking raw materials pass between the first screen portion surfaces 11A and the second screen portion surfaces 11B facing each other, turbulence occurs inside the recess portions C. Due to the turbulence, the papermaking raw materials flow back into the supply-side 1X to prevent the foreign materials F in the papermaking raw materials from moving to the discharge-side 1Y (see FIG. 5).

Due to the turbulence inside the recess portions C, the foreign materials F in the papermaking raw materials are taken into the recess portions C (see FIG. 5). The foreign materials F in the recess portions C are returned to the supply-side 1X when the papermaking raw materials flow back into the supply-side 1X from the discharge-side 1Y due to the negative pressure on the supply-side 1X caused by the rotational movement of the stirring member 2 (see FIG. 6). Accordingly, the foreign materials F are prevented from being mixed with the selected good fibers.

When the elongated slits S has a small width, it is easy to clog the slits S if a large quantity of the papermaking raw materials flow into the supply-side 1X from the discharge-side 1Y. When the papermaking raw materials flow back into the supply-side 1X from the discharge-side 1Y (see FIG. 6), the turbulence formed inside the recess portions C prevents the papermaking raw materials from flowing into the supply-side 1X from the discharge-side 1Y to some extent, thereby preventing the clogging.

Incidentally, in the above-mentioned embodiment, in the first screen portion surfaces 11A and the second screen portion surfaces 11B, the recess portions are formed in the first screen portion surfaces 11A. The present invention is not limited to the embodiment described above. In the first screen portion surfaces 11A and the second screen portion surfaces 11B, the recess portions may be formed in the second screen portion surfaces 11B (not shown). Also, the recess portions C may be formed in the first screen portion surfaces 11A and the second screen portion surfaces 11B, respectively (not shown).

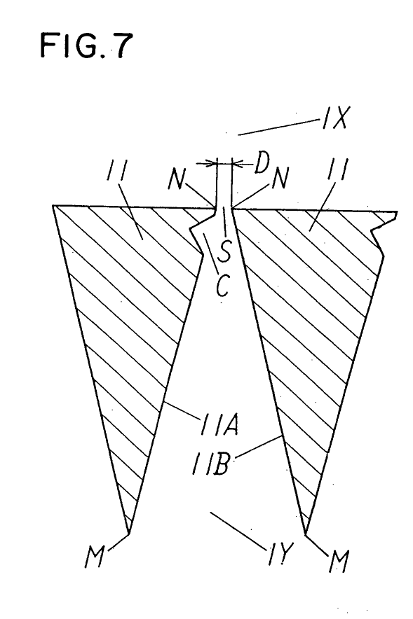

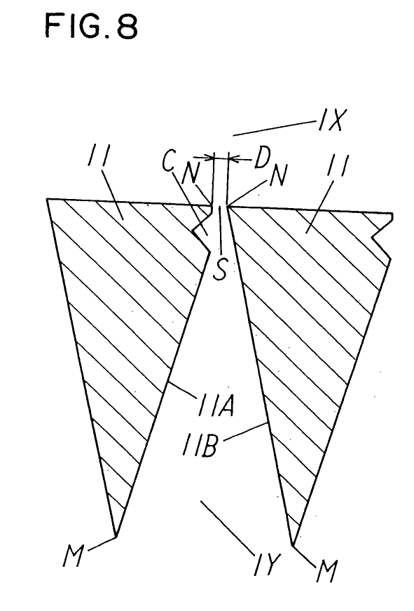

In the embodiment, the recess portions C are formed in parallel parts of the first screen portion surfaces 11A and the second screen portion surfaces 11B facing each other. The present invention is not limited to the above-mentioned embodiment. For example, as shown in FIG. 7, the recess portions C may be provided in the widening parts gradually widening toward the discharge-side 1Y. As shown in FIG. 8, the recess portions C may be provided in adjacent parts wherein the first screen portion surfaces 11A and the second screen portion surfaces 11B facing each other are not parallel. In FIGS. 7 and 8, the same symbols are used for the parts same as those in the above-mentioned embodiments (FIGS. 1 and 6), and explanations are omitted.

In the embodiments, the screen device is an inward flow screen, in which the stirring member 2 facing the outer surface of the screen 1 is provided and the papermaking raw materials flow inwardly from outside the screen 1 to be separated. The present invention is not limited to the above embodiment. The stirring member 2 may face the inner surface of the screen (not shown), i.e., an outward flow screen, so that the papermaking raw materials flow outwardly from inside the screen 1 to be separated.

In the embodiment, the screen 1 includes the elongated members 11 lined up circularly with a space in between. The invention is not limited to the embodiment. The elongated members 11 may be linearly arranged (not shown). In addition, the elongated members 11 are not limited to the bar members. The elongated members 11 may be formed of flat plates and cylindrical plates to form a screen, and the elongated slits (not shown in the figure) are provided in the screen. A cross section of the elongated slits perpendicular to the longitudinal direction includes a first screen portion surface and a second screen portion surface facing each other. In the first screen portion surface and the second screen portion surface, a recess portion may be formed in at least the first screen portion surface.

In the invention, in the first screen portion surfaces 11A and the second screen portion surfaces 11B, the recess portions C are formed in at least the first screen portion surfaces 11B. Each recess portion C are located at the position closer to the narrowest facing portion N wherein the distance D between each first screen portion surface 11A and each second screen portion surface 11B facing each other becomes smallest relative to each outlet end M of the first screen portion surface 11A and the second screen portion surface 11B facing each other through which the papermaking raw materials flow out (see FIGS. 5 to 8).

The disclosure of Japanese Patent Application No. 2004-232533, filed on Aug. 9, 2004, is incorporated in the application.

While the invention has been explained with reference to the specific embodiments of the invention, the explanation is illustrative and the invention is limited only by the -appended claims.

What is claimed is:

1. A screen device for removing foreign materials from papermaking raw materials, comprising:
a plurality elongated members arranged parallel to each other, at least one elongated member having a first screen surface and at least another elongated member situated adjacent to the at least one elongated member having a second screen surface so that the first screen surface and the second screen surface face each other to form a slit for passing the papermaking raw materials therebetween, at least one of the first and second surfaces having a recess portion extending along a longitudinal direction thereof.

2. A screen device according to claim 1, wherein said recess portion is situated at a position closer to a narrowest facing portion between the first screen surface and the second screen surface.

3. A screen device according to claim 2, wherein said recess portion is situated at a position close to an inlet in a direction that the papermaking raw materials flow.

4. A screen device according to claim 3, wherein said first and second screen surfaces have portions facing substantially parallel to each other, said recess portion being formed in said portion substantially parallel to each other.

5. A screen device according to claim 2, wherein each of said elongated members has a portion having a triangle shape in cross section perpendicular to a direction that the elongated member extends so that a distance between the elongated members increases toward an outlet of the elongated members in the direction that the papermaking raw materials flow.

6. A screen device according to claim 2, wherein each of said recess portions has a triangle shape in cross section perpendicular to a direction that the elongated member extends.

7. A screen device according to claim 1, further comprising a stirring member situated adjacent to the elongated members to wash the slit.
